(19) United States
(12) Patent Application Publication
(10) Pub. No.: US 2011/0170993 A1
(43) Pub. Date: Jul. 14, 2011

(54) APPARATUS, SYSTEM AND METHOD FOR TRANSPORTING AND STORING ROD-SHAPED ARTICLES

(75) Inventor: Dimitar Yanchev, Plovdiv (BG)

(73) Assignee: AIGER GROUP AG, Zug (CH)

(21) Appl. No.: 12/686,070

(22) Filed: Jan. 12, 2010

(51) Int. Cl. B65G 65/16

(52) U.S. Cl. 414/416.01; 414/403; 414/810; 414/811

(57) ABSTRACT

A system for transporting and storing rod shaped articles, including a loading station, the loading station including an inlet aperture, an outlet aperture, a rotor rotatably disposed within the loading station, and a buffer container. The system also including an unloading station, the unloading station including an inlet aperture, a transfer conduit, a rotor rotatably disposed within the unloading station, and a buffer container. The system further including a mobile container selectively coupleable to the loading station and the unloading station, and further including an inlet/outlet aperture defined in a wall thereof and a plurality of translatable magazines disposed within the mobile container.

### BACKGROUND

The production of smokers' goods in the tobacco industry generally requires the manufacture of various rod-shaped articles. Such rod shaped articles may be filtered or filterless cigarettes, cigarette filter portions, cigarillos, cigars, and other, similar articles. The cigarette production process often involves first manufacturing the rod shaped articles, combining them with other rod-shaped articles if necessary (for example a cigarette portion and a filter portion), and then processing the rod shaped-articles and packaging them into packs and cartons.

The steps of manufacturing, combining, and processing and packaging rod-shaped articles often necessitate the use of several, separate machines. Consequently, during the production process, the rod-shaped articles may need to be transferred between the several, separate machines; for example, from production machines such as cigarette-making or filter-making machines to processing machines such as packaging machines. A simple, effective and efficient means of transferring rod-shaped articles between the various machines involved in their manufacture is therefore desirable. A means of securely and safely storing the rod-shaped articles is also desirable.

Several methods of transferring rod-shaped articles are presently in use by the tobacco industry. Generally, such methods may be automatic, semi-automatic or manual. Automatic methods may involve transferring the mass flow of cigarettes directly from a machine to a subsequent machine. However, automatic methods are generally expensive, have large footprints, and are difficult to reconfigure if a brand or size change is needed. Such methods may also not allow for storage of rod-shaped articles in between the production steps. Semi-automatic methods may involve using loading units to transfer the mass flow of cigarettes from a machine into trays, which may then be moved to the subsequent machine, where they are removed from the trays by unloading units. Such transfers may also be done manually. However, semi-automatic and manual transfer methods are labor-intensive and require a significant amount of manpower to achieve efficiency.

### SUMMARY

A system for transporting and storing rod shaped articles, including a loading station, the loading station including an inlet aperture, an outlet aperture, a rotor rotatably disposed within the loading station, and a buffer container. The system also including an unloading station, the unloading station including an inlet aperture, a transfer conduit, a rotor rotatably disposed within the unloading station, and a buffer container. The system further including a mobile container selectively coupleable to the loading station and the unloading station, and further including an inlet/outlet aperture defined in a wall thereof and a plurality of translatable magazines disposed within the mobile container.

A method for transporting and storing rod-shaped articles, including coupling a mobile container to a loading station, accepting a mass flow of rod-shaped articles into the loading station, transferring the mass flow of rod-shaped articles from the loading station to the mobile container; decoupling the mobile container from the loading station, maintaining the rod-shaped articles within said mobile container, coupling the mobile container to an unloading station, transferring the rod-shaped articles the said mobile container to the unloading station, generating a mass flow of rod shaped articles, and withdrawing the mass flow of the rod-shaped articles from the unloading station.

### BRIEF DESCRIPTION OF THE DRAWINGS

FIG. 1a is an exemplary diagram of a system for transporting and storing rod-shaped articles.

FIG. 1b is an exemplary diagram of a manufacturing machine for rod-shaped articles.

FIG. 1c is an exemplary diagram of a manufacturing machine for multi-segmented rod-shaped articles.

FIG. 2a is an exemplary diagram of a manufacturing and combining machine for rod-shaped articles.

FIG. 2b is an exemplary diagram of a packaging machine for rod-shaped articles.

FIG. 3 is a cutaway view of an exemplary embodiment of a mobile container.

FIG. 4 is a cross-sectional view of an exemplary embodiment of a loading station coupled to an exemplary embodiment of a mobile container.

FIGS. 5a-5e is a cutaway view showing an exemplary method of loading and unloading an exemplary embodiment of a mobile container.

FIG. 6 is a cross-sectional view of an exemplary embodiment of a loading station coupled to an exemplary embodiment of a mobile container.

FIG. 7 is an isometric view of an exemplary stack of mobile containers.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation. Furthermore, as used herein, the terms “rod-shaped articles” or “rod-like articles” shall refer to filtered or filterless cigarettes, cigarette tobacco portions, filter portions, cigarillos, cigars, or any other article having a cylindrical shape that is known to one having ordinary skill in the art.

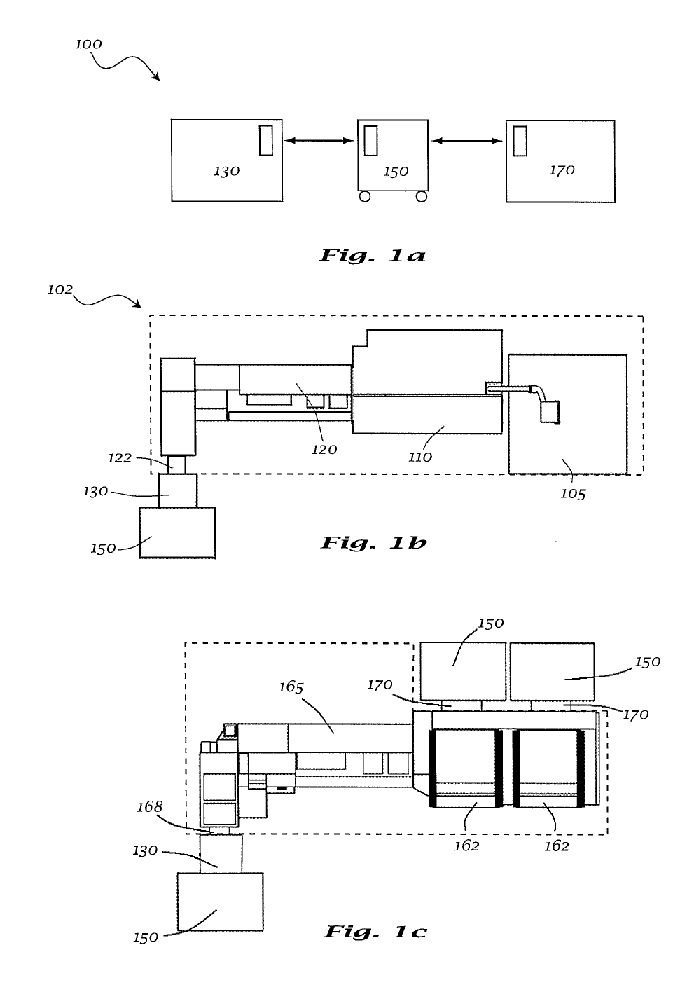

Referring to exemplary FIG. 1a and generally referring to exemplary FIGS. 1-7, a system 100 for transporting and storing rod-shaped articles is disclosed. System 100 may include a loading station 130, a mobile container 150, and an unloading station 170. Loading station 130, mobile container 150 and unloading station 170 may be configured such that that mobile container 150 may be alternatively coupled to either loading station 130 or unloading station 170. Loading station 130 and unloading station 170 may also each be configured to couple to equipment generally used in the production of smokers' goods.

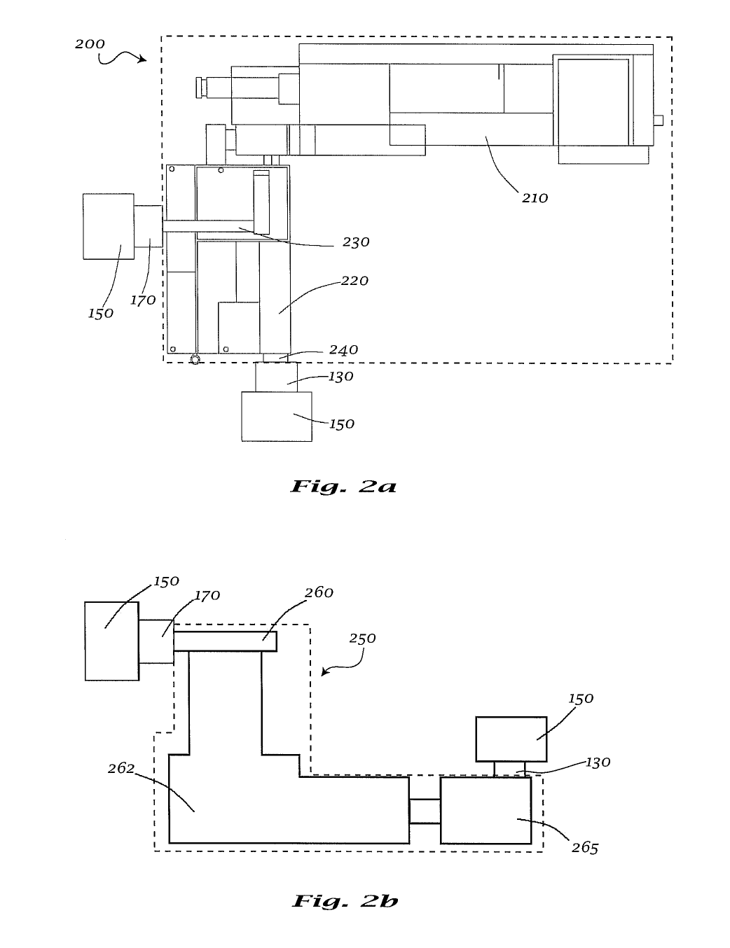

Exemplary FIGS. 1b-2b show exemplary embodiments of system 100 in use with exemplary embodiments of equipment generally used in the production of smokers' goods. Such equipment may be familiar to one having ordinary skill in the art and is therefore illustrated schematically.

Exemplary FIG. 1b shows an exemplary embodiment of a manufacturing machine 102 for rod-shaped articles. Manufacturing machine 102 can include several components. As an illustrative example, a machine 102 that is configured for filter manufacture can include a filter tow bin 105, a filter tow preparation machine 110, a filter rod making machine 120 and a final stage unit 122. The filter tow is withdrawn from bin 105 and passes through machines 110, 120 where it is prepared and transformed into a filter rod. The filter rod then enters final stage unit 122 where it may be cut into individual filter portions, which may then be checked for conformity to desired quality, size and other standards. Coupled to final stage unit 122 of machine 100 may be loading station 130, and coupled to loading station 130 may be an empty or partially full mobile container 150. Filter portions exiting from final stage unit 122 can pass into loading station 130 and thereafter into mobile container 150 as described further herein.

Exemplary FIG. 1c shows an exemplary embodiment of a manufacturing machine 160 for multi-segmented rod-shaped articles. Manufacturing machine 160 can include several components. As an illustrative example, a machine 160 that is configured for multi-segmented filter manufacture can include at least two preparation modules 162, a filter rod making machine 165 and a final stage unit 168. Coupled to each of at least two preparation modules 162 may be unloading station 170, and coupled to unloading station 170 may be a full or partially full mobile container 150. Filter portions may be withdrawn from mobile container 150 through unloading station 170 as described further herein. The filter portions can then pass through at least two preparation modules 162 and filter rod making machine 165, where the filter portions may be prepared, combined, and transformed into a filter rod. The filter rod then enters final stage unit 168 where it may be cut into individual filter portions, which may then be checked for conformity to desired quality, size and other standards. Coupled to final stage unit 168 of machine 160 may be loading station 130, and coupled to loading station 130 may be an empty or partially full mobile container 150. Filter portions that exit from final stage unit 122 can pass into loading station 130 and thereafter into mobile container 150 as described further herein.

Exemplary FIG. 2a shows an exemplary embodiment of a manufacturing and combining machine 200 for rod-shaped articles. Manufacturing and combining machine 200 can include several components. As an illustrative example, a machine 200 that is configured for cigarette manufacture and filter attachment can include a cigarette rod making machine 210, a filter rod attachment machine 220, a first transport device 230, and a second transport device 240. Coupled to first transport device 230 may be unloading station 170, and coupled to unloading station 170 may be a full or partially full mobile container 150. Cigarette tobacco portions may be manufactured by cigarette rod making machine 210 according to methods known to one having ordinary skill in the art. The cigarette tobacco portions then pass into filter rod attachment machine 220. Filter portions may be withdrawn from mobile container 150 through unloading station 170 as described further herein. Filter portions may then be moved via first transport device 230 into filter rod attachment machine 220, where they are combined with cigarette tobacco portions to make cigarette rods. The combined cigarette rods are then transported from filter rod attachment machine 220 via second transport device 240. Coupled to second transport device 240 may be loading station 130, and coupled to loading station 130 may be an empty or partially full mobile container 150. Filter portions that exit from second transport device 240 can pass into loading station 130 and thereafter into mobile container 150 as described further herein.

Exemplary FIG. 2b shows an exemplary embodiment of a packaging machine 250 for rod-shaped articles. Packaging machine 250 can include several components. As an illustrative example, a packaging machine 250 that is configured for packaging cigarettes can include a feeding device 260, a cigarette packing machine 262, a wrapping and boxing machine 265, and an overwrapping machine 270. Coupled to feeding device 260 may be unloading station 170, and coupled to unloading station 170 may be a full or partially full mobile container 150. Cigarettes may be withdrawn from mobile container 150 through unloading station 170 as described further herein. Filter portions may then be moved via feeding device 260 into packing machine 262, and then to wrapping and boxing machine 265 and overwrapping machine 270. Coupled to overwrapping machine 270 may be loading station 130, and coupled to loading station 130 may be an empty or partially full mobile container 150. Cigarette cases that exit from overwrapping machine 270 can pass into loading station 130 and thereafter into mobile container 150.

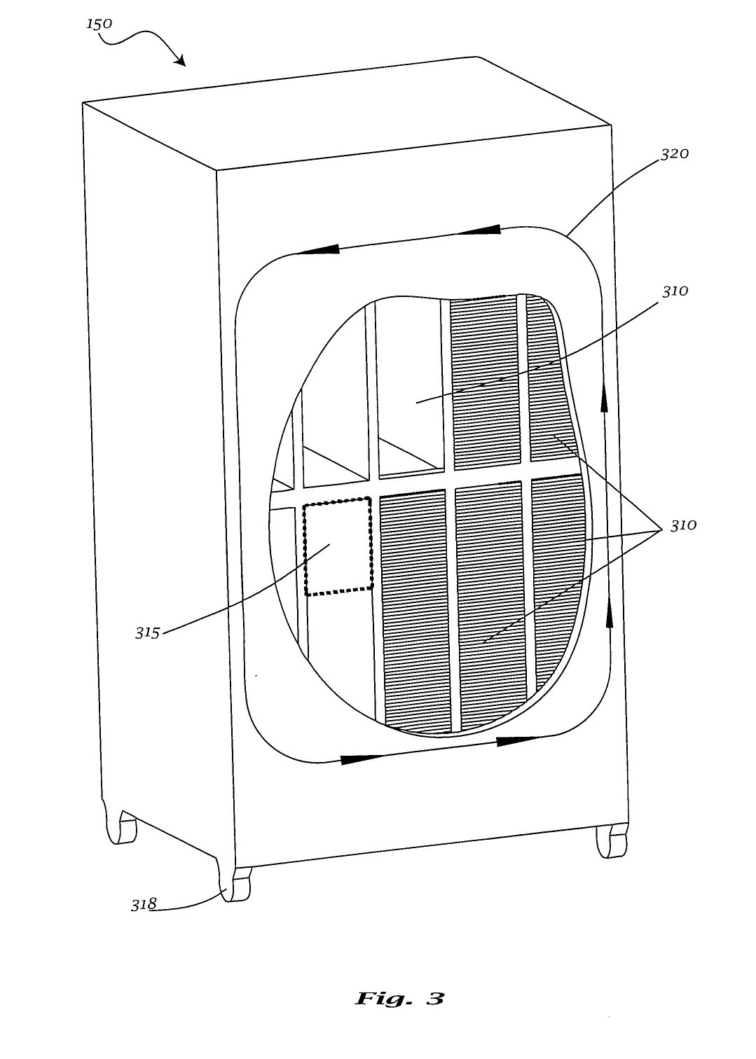

Turning now to exemplary FIG. 3, an exemplary embodiment of a mobile container 150 is shown. Mobile container 150 may include an internal cavity 305, a plurality of separate magazines 310 movably disposed within cavity 305, an inlet/outlet aperture 315 and supports 318. Supports 318 may be wheels, tracks, skis, or any other known support that enables mobile container 150 to move freely on a surface. Mobile container 150 may also include adaptations for transport by various mobile transport devices such as forklifts, powered carts, or any other similar device. Such adaptations may be, for example, reinforced points in the structure of container 150, recesses or receptacles for rails or forks, or other adaptations known to one having ordinary skill in the art.

Aperture 315 may be defined in a vertical portion of mobile container 150, for example, the front wall. Magazines 310 may be disposed within cavity 305 of mobile container 150 such that magazines 310 are arranged into a plurality of vertically stacked rows. Both the number of vertically stacked rows and the number of magazines 310 per row may be customized as desired by the user. In one exemplary embodiment, as shown in exemplary FIG. 3, mobile container 150 may have a lower row 312 and an upper row 314, each of rows 312, 314 being composed of a plurality of magazines 310 disposed horizontally and side-by-side in relation to each other. Magazines 310 may be movably mounted within cavity 305 and may be capable of lateral (side-to-side) and vertical translation. In one exemplary embodiment, magazines 310 may translate along exemplary path 320.

Aperture 315 may be sized such that the width of aperture 315 is substantially similar to the width of a magazine 310. When magazines 310 are stationary, a magazine 310 can be positioned in a loading position whereby aperture 315 and magazine 310 are substantially in alignment, thereby facilitating the loading of rod-shaped articles into magazine 310 via aperture 315.

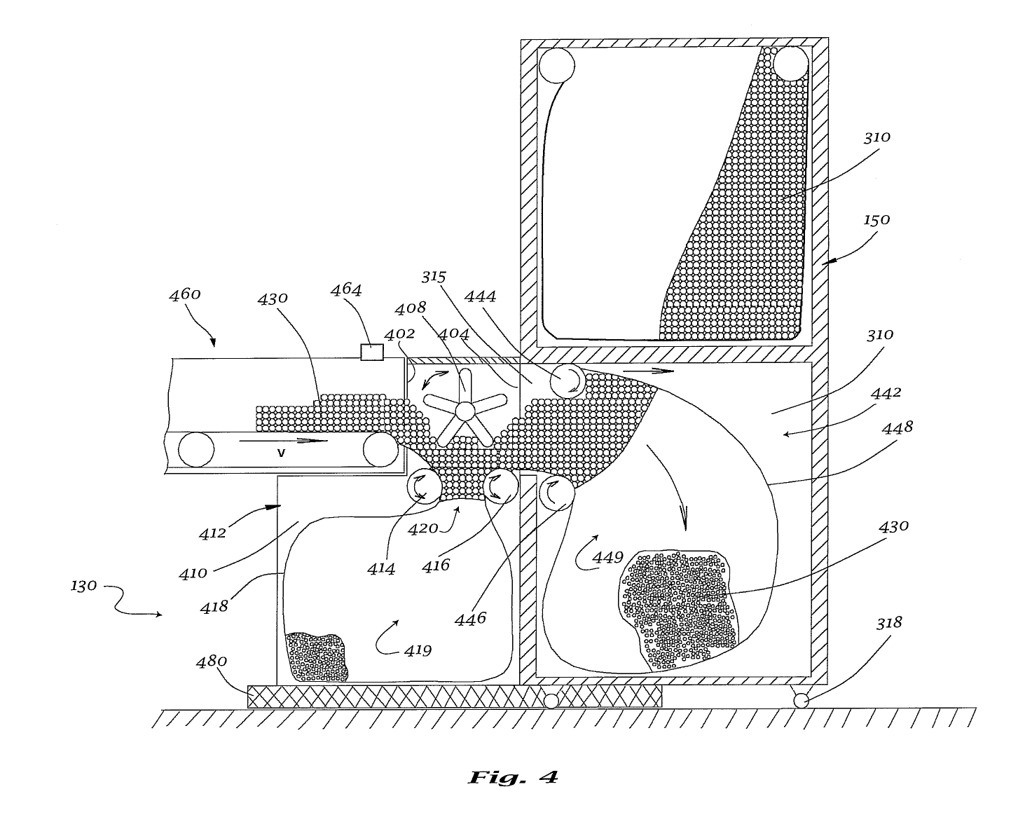

Exemplary FIG. 4 illustrates an exemplary method of filling a mobile container 150 with rod shaped articles. The mobile container 150 may be coupled to loading station 130 via docking device 480. Docking device 480 may be coupled to loading station 130 and may include connections for any electrical, hydraulic, mechanical or other desired power sources that may be necessary to allow mobile container 150 to operate as described herein. Such connections may be configured to facilitate “plug-and-play” style automatic coupling of all desired connections when mobile container 150 is coupled to docking device 480. Docking device 480 may further be movable and may facilitate securing mobile container 150 and transferring mobile container 150 into the appropriate position for coupling mobile container 150 to loading station 130.

Loading station 130 may include a first aperture 402, a second aperture 404, a rotor 408 and a buffer container 410. First aperture 402 may be located proximate to a mass flow transport device 460. Mass flow transport device 460 may be a final stage unit 122, a transport device 240, an overwrapping machine 270, or any other device known in the art that may transport a mass flow 430 of rod-shaped articles. Mass flow transport device 460 may include a transport mechanism 462 and a sensor 464. Sensor 464 may determine the amount, volume, and other characteristics of mass flow 430 and adjust the speed of transport mechanism 462 as necessary for manageable handling of mass flow 430 without imparting damage to the rod-shaped objects in mass flow 430. Sensor 464 can be any type of sensor, such as, for example, optical, laser, inductive, capacity, microwave, any other type of wave or any other known type of sensor that can allow for the sensing of any desired property.

Buffer container 410 may include a cavity 412 defined therein, a pair of rollers 414, 416 rotatably mounted therein, and a flexible belt 418. Rollers 414, 416 may be driven by a servomotor and may rotate with variable speed and direction. Rollers 414, 416 may be positioned below rotor 408 and may be positioned such that an aperture 420 is defined between roller 414 and roller 416. Flexible belt 418 may be wound on rollers 416, 416. When belt 418 is in a fully-wound configuration, it may be positioned such that it blocks aperture 420, thereby reducing the likelihood of mass flow 430 passing into cavity 412. As flexible belt 418 unwinds, it may define a pouch 419 disposed between aperture 420 and flexible belt 418. Flexible belt 418 may have a width substantially equal to the width of cavity 412, and may have a length such that, when flexible belt 418 is unwound, the volume of pouch 419 is approximately similar to the volume of cavity 412.

Magazine 310 of mobile container 150 may include a cavity 442 defined therein, a pair of rollers 444, 446 slidably and rotatably mounted therein, and a flexible belt 448. Rollers 444, 446 may be driven by a servomotor and may rotate with variable speed and direction. Flexible belt 448 may be wound on rollers 444, 446. As flexible belt 448 unwinds, it may define a pouch 449 disposed between aperture 315 and flexible belt 448. When magazine 310 is positioned in the loading position, rollers 444, 446 may be positioned proximate to aperture 315, thereby allowing mass flow 430 to pass into pouch 449. Flexible belt 448 may have a width substantially equal to the width of cavity 442, and may have a length such that, when flexible belt 448 is unwound, the volume of pouch 449 is approximately similar to the volume of cavity 442.

As mass flow 430 of rod-shaped articles exits mass flow transport device 460, it is deposited proximate to rotor 408. The rotational motion of rotor 408 may facilitate the transfer of mass flow 430 from mass flow transport device 460 through loading station 130 and into magazine 310 of mobile container 150 until magazine 310 is full. The loading process of magazine 310 will be described in detail further below.

Once magazine 310 is filled to capacity, it becomes necessary to displace full magazine 310 from the loading position and transfer an empty magazine 310 into the loading position. As the magazine switching process may take a non-trivial amount of time, it is important to maintain a continuously-moving flow of rod-shaped articles so that flow transport device 460 and the antepositioned thereto rod-shaped article manufacturing equipment may operate continuously, without interruptions or stoppages, thereby facilitating the maximization of efficiency in the production process. These objectives may be facilitated by buffer container 410.

As the positions of magazines 310 are being shifted within mobile container 150, rollers 414, 416 may begin to unwind flexible belt 418 and rotor 408 may begin to facilitate the transfer of mass flow 430 towards aperture 420 rather than aperture 404. The speed of rollers 414, 416 may be controlled by sensor 464. As rollers 414, 416 unwind, the volume of pouch 419 increases within cavity 412 of buffer container 410 due to the increased unwound length of flexible belt 418. The increased volume of pouch 419 allows rod-shaped articles from mass flow 430 to be deposited in pouch 419 while magazines 310 are being switched. The gradual increasing in volume of pouch 419 also facilitates depositing rod-shaped articles therein without imparting damage to the rod-shaped articles. Once an empty magazine 310 is in the loading position, rollers 414, 416 may stop unwinding flexible belt 418 and rotor 408 may recommence facilitating the transfer of mass flow 430 towards aperture 404 and subsequently magazine 310. Rollers 414, 416 may then begin to rewind flexible belt 418 thereby shortening the unwound length of flexible belt 418 and reducing the volume of pouch 419. Consequently, rod-shaped articles from pouch 419 are commingled with rod shaped articles in mass flow 430 and may subsequently pass into magazine 310. Pouch 419 may be emptied prior to the next switch of magazines 310 and is therefore again ready to act as a buffer during the next switch of magazines 310.

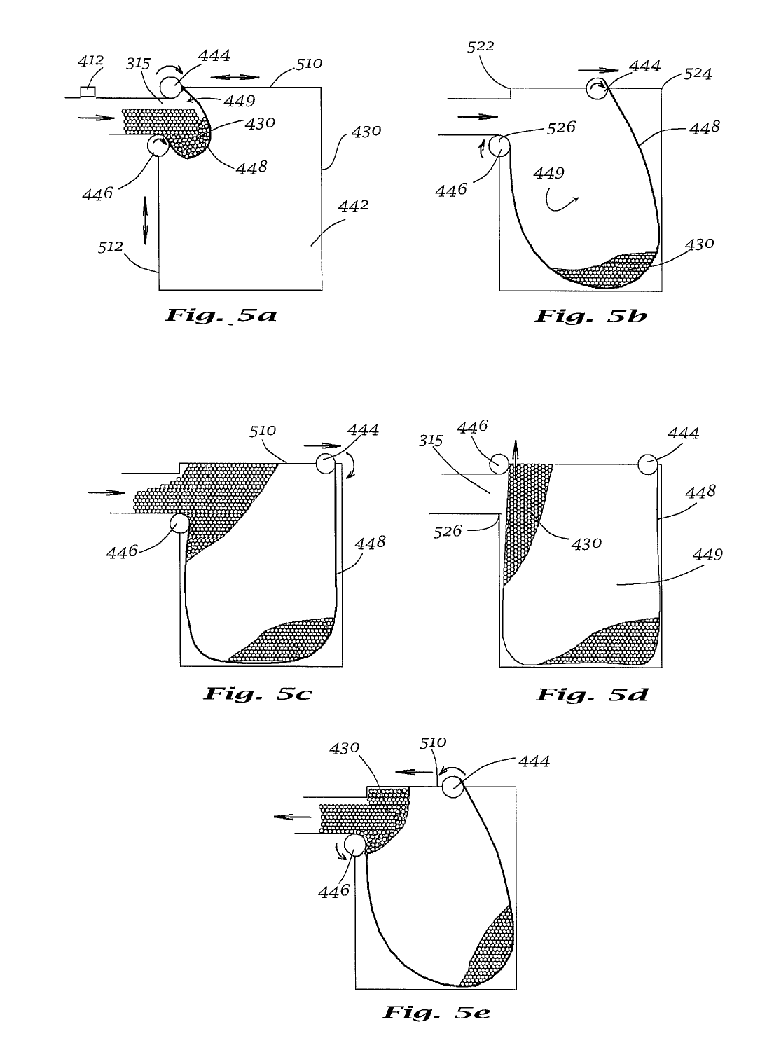

Exemplary FIGS. 5a-5e illustrate an exemplary method of loading and unloading a magazine 310 of mobile container 150. FIG. 5a shows the initial stage of filling an empty magazine 310. At this stage, flexible belt 448 is almost completely wound onto rollers 444, 446 and consequently the volume of pouch 449 is substantially minimized. Magazine 310 may now be ready to receive mass flow 430 of rod-shaped articles. Rollers 444, 446 are furthermore slidably mounted within magazine 310 and may translate along tracks 510, 512. At this stage, roller 444 is located at position 522 and roller 446 is located at position 526. As shown in FIG. 5b, as more rod-shaped articles are deposited within pouch 449, rollers 444, 446 may unwind flexible belt 448 thereby increasing the volume of pouch 449. Simultaneously, roller 444 may translate horizontally along track 510 towards position 524, thereby maximizing the volume of pouch 449.

FIG. 5c shows a magazine 310 substantially near capacity. At this stage, roller 444 is located at position 524 and roller 446 is located at position 526. Rollers 444, 446 may continue to unwind belt flexible belt 448 until magazine 310 is substantially filled to maximum capacity. FIG. 5d shows magazine 310 at maximum capacity and ready to be moved from the loading position. At this stage, roller 446 may translate vertically along track 512 from position 526 to position 522 while further unwinding flexible belt 446. When roller 446 is located at position 522, aperture 315 is effectively sealed by flexible belt 446, thereby lowering the likelihood of rod-shaped articles exiting pouch 449 and magazine 310.

FIG. 5e shows a magazine 310 in the process of unloading the contents thereof. This process may be substantially the reverse of the loading process. First, roller 446 may translate vertically along track 512 from position 522 to position 526 while partially rewinding flexible belt 448, thereby unsealing aperture 315. Subsequently, roller 444 may translate horizontally from position 524 to position 522 while rollers 444, 442 rewind flexible belt 448, reducing the volume of pouch 449 and transferring the rod-shaped articles therein through aperture 315. The rod-shaped articles may then be transferred into an unloading station 170. Once magazine 310 is substantially empty, roller 444 may be located at position 522, roller 446 may be located at position 526, and flexible belt 448 may be completely wound onto rollers 444, 446 such that the volume of pouch 449 is minimized.

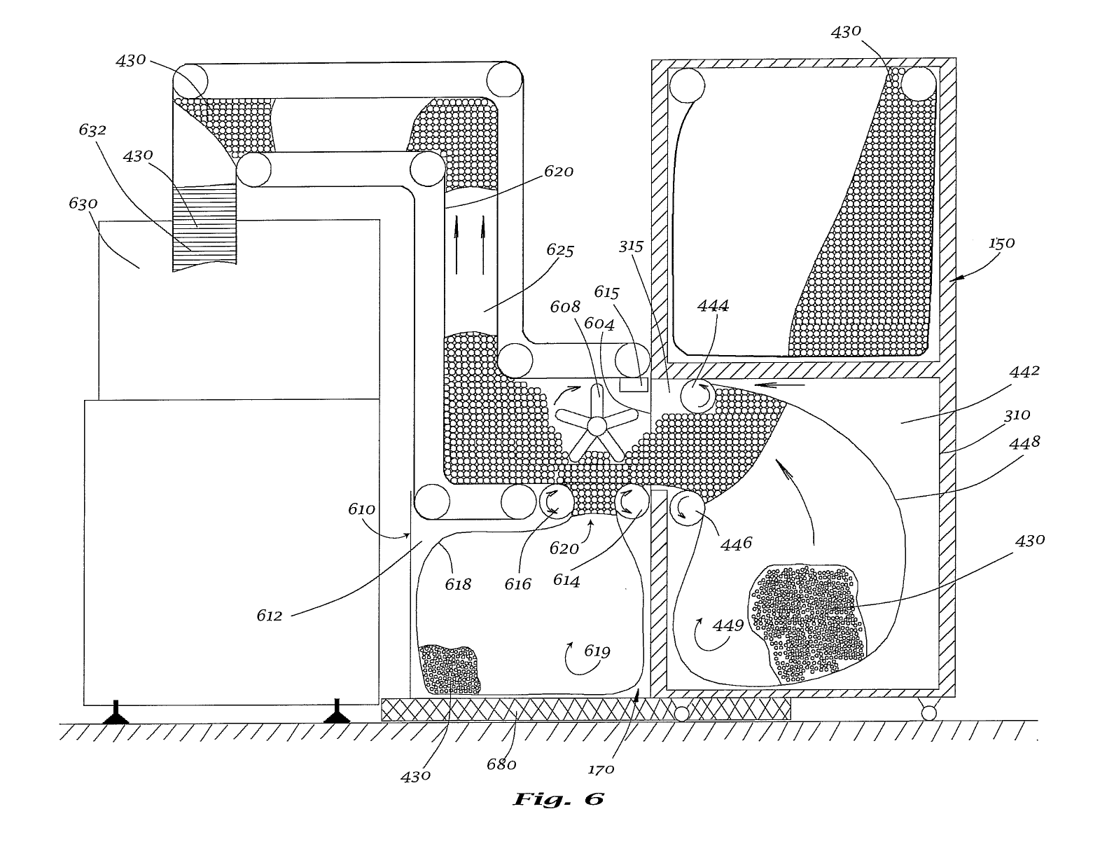

Exemplary FIG. 6 illustrates an exemplary method of emptying a mobile container 150. The mobile container 150 may be coupled to unloading station 170 via docking device 680. Docking device 680 may be coupled to unloading station 170 and may include connections for any electrical, hydraulic, mechanical or other desired power sources that may be necessary to allow mobile container 150 to operate as described herein. Such connections may be configured to facilitate “plug-and-play” style automatic coupling of all desired connections when mobile container 150 is coupled to docking device 680. Docking device 680 may further be movable and may facilitate securing mobile container 150 and transferring mobile container 150 into the appropriate position for coupling mobile container 150 to unloading station 170.

Loading station 130 may include an aperture 604, a rotor 608, a buffer container 610, a sensor 615 and a transfer conduit 625. Transfer conduit 625 may be coupled to a receiving unit 632 of a processing machine 630. Sensor 615 may determine the amount, volume, and other characteristics of mass flow 430 and adjust the speed of transfer conduit 625 as necessary for manageable handling of mass flow 430 without imparting damage to the rod-shaped objects in mass flow 430. Sensor 615 can be any type of sensor, such as, for example, optical, laser, inductive, capacity, microwave, any other type of wave or any other known type of sensor that can allow for the sensing of any desired property.

Buffer container 610 may include a cavity 612 defined therein, a pair of rollers 614, 616 rotatably mounted therein, and a flexible belt 618. Rollers 614, 616 may be driven by a servomotor and may rotate with variable speed and direction. Rollers 614, 616 may be positioned below rotor 608 and may be positioned such that an aperture 620 is defined between roller 614 and roller 616. Flexible belt 618 may be wound on rollers 616, 616. When belt 618 is in a fully-wound configuration, it may be positioned such that it blocks aperture 620, thereby reducing the likelihood of mass flow 630 passing into cavity 612. As flexible belt 618 unwinds, it may define a pouch 619 disposed between aperture 620 and flexible belt 618. Flexible belt 618 may have a width substantially equal to the width of cavity 612, and may have a length such that, when flexible belt 618 is unwound, the volume of pouch 619 is approximately similar to the volume of cavity 612.

A full magazine 310 may be positioned in the loading position proximate to aperture 604 and emptied according to the process described above. Once magazine 310 is empty, it becomes necessary to displace empty magazine 310 from the loading position and transfer a full magazine 310 into the loading position. As the magazine switching process may take a non-trivial amount of time, it is important to maintain a continuously-moving flow of rod-shaped articles so that transfer conduit 625 and processing machine 630 may operate continuously, without interruptions or stoppages, thereby facilitating the maximization of efficiency in the production process. These objectives may be facilitated by buffer container 610.

As mass flow 430 of rod-shaped articles exits magazine 310, it is deposited proximate to rotor 608. The rotational motion of rotor 608 may facilitate the transfer of mass flow 430 from magazine 310 to transfer conduit 625 and buffer container 610 simultaneously. At this point, rollers 614, 616 may begin to unwind flexible belt 618, thereby increasing the volume of pouch 619 within cavity 612 of buffer container 610. The speed of rollers 614, 616 may be controlled by sensor 464 and may be adjusted as necessary to maintain a continuous mass flow 430 through transfer conduit 625 while simultaneously directing a portion of mass flow 430 to pouch 619. The gradual increasing in volume of pouch 619 also facilitates depositing rod-shaped articles therein without imparting damage to the rod-shaped articles. Once magazine 310 is empty, the magazine switching process may commence. At this time, rollers 614, 616 may begin to rewind flexible belt 618, thereby reducing the volume of pouch 619 and directing the rod-shaped articles therein towards rotor 608, which may facilitate moving the rod-shaped articles towards transfer conduit 625, thereby maintaining a continuous mass flow 430 of rod-shaped articles to receiving unit 632 of processing machine 630. Pouch 619 may be emptied during the switching process of magazines 310 and is therefore again ready to act as a buffer during the unloading of a subsequent magazine 310. Transfer conduit 625 may include a plurality of separate bands 620 that facilitate the movement of mass flow 430 towards receiving unit 632 of processing machine 630.

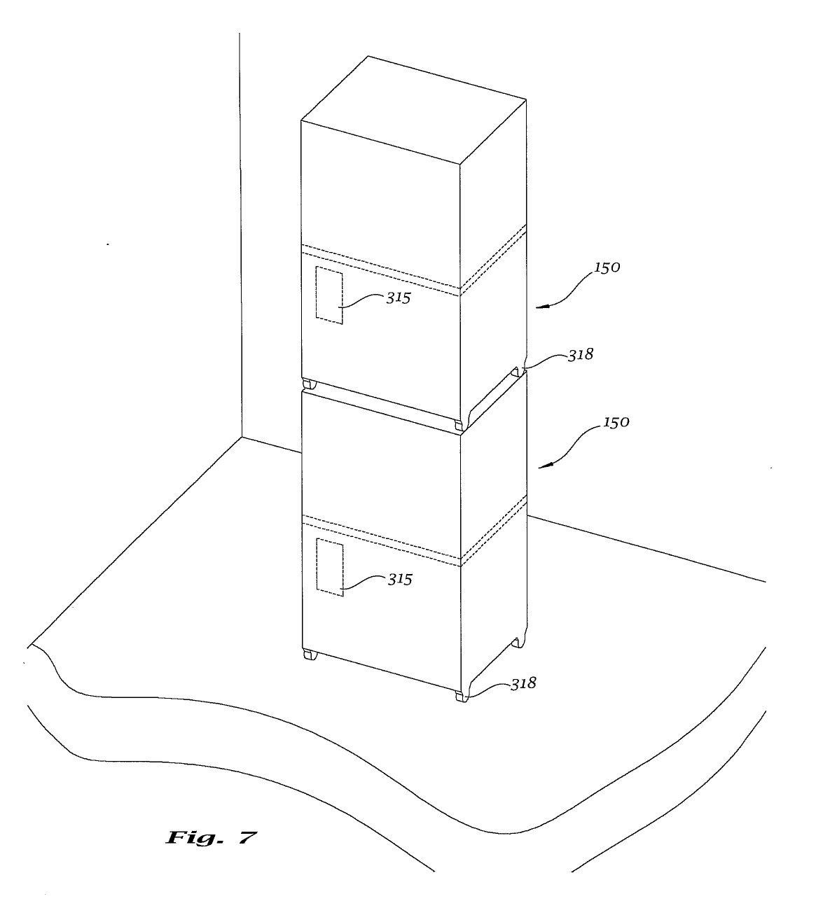

Exemplary FIG. 7 shows exemplary embodiments of mobile containers 150 in a stacked configuration. Mobile containers 150 may be configured to facilitate easy stacking of mobile containers 150 and may further be configured to facilitate maintaining the stability of the stacks of mobile containers 150. For example, a mobile container 150 may include recesses (not shown) in its top surface that are configured to receive supports 318 of another mobile container 150. Additionally, the size of mobile containers 150 and the number of magazines 310 therein may be customizable as desired by the user according to the type and quantity of rod-shaped articles to be stored. A mobile container 150 may further include the ability to be hermetically sealed so that rod-shaped articles may be stored therein for extended periods of time.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for transporting and storing rod shaped articles between a first location and a second location, comprising:
a loading station disposed at the first location, said loading station further comprising an outlet aperture, a rotor rotatably disposed within said loading station, and a buffer container;
an unloading station disposed at the second location, said unloading station further comprising an inlet aperture, a rotor rotatably disposed within said unloading station, and a buffer container; and
a mobile container selectively coupleable to said loading station and said unloading station, said mobile container further comprising an inlet/outlet aperture defined in a vertical wall thereof and a plurality of translatable magazines disposed within said mobile container.

2. The system of claim 1, wherein each of said plurality of translatable magazines further comprises:
an inlet/outlet aperture defined in a vertical wall thereof;
an inner cavity;
at least one roller rotatably and slidably disposed within said cavity; and
a flexible belt coupled to and wound around said at least one roller, said flexible belt having an adjustable length and defusing a pouch having an adjustable volume, said adjustable volume of said pouch being in correlation with said adjustable length of said belt.

3. The system of claim 1, wherein said buffer container of said loading station further comprises:
an inner cavity;
at least one roller rotatably disposed within said cavity; and
a flexible belt coupled to and wound around said at least one roller, said flexible belt having an adjustable length and defining a pouch having an adjustable volume, said adjustable volume of said pouch being in correlation with said adjustable length of said belt.

4. The system of claim 1, wherein said buffer container of said unloading station further comprises:
an inner cavity;
at least one roller rotatably disposed within said cavity; and
a flexible belt coupled to and wound around said at least one roller, said flexible belt having an adjustable length and defining a pouch having an adjustable volume, said adjustable volume of said pouch being in correlation with said adjustable length of said belt.

5. A system for transporting and storing rod-shaped articles between a first location and a second location, comprising:
a mobile storage container selectively coupleable to a loading station and an unloading station and comprising an inlet/outlet aperture and a plurality of translatable magazines disposed therein, each of said magazines further comprising a cavity defined therein, a first roller and a second rotatably and slidably disposed within said cavity, and a flexible belt coupled to and wound around said first roller and said second roller, said flexible belt having an adjustable length and defining a pouch having an adjustable volume that is in correlation with said adjustable length of said flexible belt;
a loading station disposed at the first location, comprising a rotor rotatably disposed therein, at least one aperture, and a buffer container, said buffer container further comprising a cavity defined therein, a first roller and a second roller rotatably disposed within said cavity, and a flexible belt coupled to and wound around said first roller and said second roller, said flexible belt having an adjustable length and defining a pouch having an adjustable volume that is in correlation with said adjustable length of said flexible belt;
an unloading station disposed at the second location, comprising a rotor rotatably disposed therein, at least one aperture, and a buffer container, said buffer container further comprising a cavity defined therein, a first roller and a second roller rotatably disposed within said cavity, and a flexible belt coupled to and wound around said first roller and said second roller, said flexible belt having an adjustable length and defining a pouch having an adjustable volume that is in correlation with said adjustable length of said flexible belt.

6. The system of claim 5, wherein said flexible belt disposed within either of said buffer containers is positioned such that said flexible belt prevents access to said buffer container when said flexible belt is fully wound.

7. A method for transporting and storing rod-shaped articles, comprising:
coupling a mobile container to a loading station;
transferring a mass flow of said rod-shaped articles from said loading station to said mobile container;
decoupling said mobile container from said loading station;
maintaining said rod-shaped articles within said mobile container;
coupling said mobile container to an unloading station; and
transferring said mass flow rod-shaped articles from said mobile container to said unloading station.

8. The method of claim 7, wherein said transferring said mass flow of said rod-shaped articles from said loading station to said mobile container further comprises:
transferring said mass flow of said rod-shaped articles to a first magazine disposed within said mobile container;
gradually expanding a variable-volume pouch within said first magazine to accept said mass flow of said rod-shaped articles until said first magazine is full;
directing said mass flow of said rod-shaped articles to a buffer container;
gradually expanding a variable-volume pouch within said buffer container to accept said mass flow of said rod-shaped articles;
replacing said first magazine with a second magazine disposed within said mobile container; and
gradually contracting said variable-volume pouch within said buffer container to extract said rod-shaped articles.

9. The method of claim 7, wherein said transferring said rod-shaped articles from said mobile container to said unloading station further comprises:
gradually contracting a variable-volume pouch within a first translatable magazine of said mobile container to extract said rod-shaped articles until said first magazine is empty;
generating a mass flow of said rod-shaped articles;
directing said mass flow of said rod-shaped articles to said unloading station and to a buffer container;
gradually expanding a variable-volume pouch within said buffer container to accept said mass flow of said rod-shaped articles;
replacing said first magazine with a second magazine disposed within said mobile container; and
gradually contracting said variable-volume pouch within said buffer container to extract said mass flow of said rod-shaped articles.

10. A system for transporting and storing rod shaped articles between a first location and a second location, comprising:
a container means for receiving, storing and transporting a mass flow of rod shaped articles, said container means further comprising a first input/output means, at least one storage means and a mobility means;
a loading means for transferring said mass flow of rod shaped articles between the first location and the container means, said loading means further comprising a mass flow directing means and a means for maintaining an uninterrupted mass flow;
an unloading means for transferring said mass flow of rod shaped articles between the container means and the second location, said unloading means further comprising a mass flow directing means and a means for maintaining an uninterrupted mass flow.

11. The system of claim 10, wherein said means for maintaining an uninterrupted mass flow is a buffering means further comprising a means for varying the volume of the buffering means.

12. The system of claim 10, wherein the at least one storage means further comprises a second input/output means, and a means for varying the volume of the storage means.

13. The system of claim 12, wherein the at least one storage means further comprises a means of preventing access to said second input/output means.
